(19) United States
(12) Patent Application Publication
(10) Pub. No.: US 2020/0054069 A1
(43) Pub. Date: Feb. 20, 2020

(54) APPARATUS FOR HEATING SMOKABLE MATERIAL

(71) Applicant: BRITISH AMERICAN TOBACCO (INVESTMENTS) LIMITED

(72) Inventors: Thomas P. BLANDINO, Cottage Grove, WI (US); Andrew P. WILKE, Madison, WI (US); James J. FRATER, Madison, WI (US); Benjamin J. PAPROCKI, Cottage Grove, WI (US)

(21) Appl. No.: 15/754,818

(22) PCT Filed: Aug. 26, 2016
(86) PCT No.: PCT/EP2016/070185

§ 371 Date: Feb. 23, 2018

Related U.S. Application Data
(63) Continuation of application No. 14/840,751, filed on Aug. 31, 2015, now abandoned.

(51) Int. Cl. A24F 47/00; H05B 6/06; H05B 6/10; H05B 6/36

(52) U.S. Cl. CPC A24F 47/008; H05B 6/36; H05B 6/108; H05B 6/06

(57) ABSTRACT

Disclosed is an apparatus for heating smokable material to volatilize at least one component of the smokable material. The apparatus includes a heating zone for receiving at least a portion of an article comprising smokable material; a magnetic field generator for generating a varying magnetic field; and an elongate heating element extending at least partially around the heating zone and comprising heating material that is heatable by penetration with the varying magnetic field to heat the heating zone.

### PRIORITY CLAIM

The present application is a National Phase entry of PCT Application No. PCT/EP2016/070185, filed Aug. 26, 2016, which claims priority from U.S. patent application Ser. No. 14/840,751, filed Aug. 31, 2015, each of which is hereby fully incorporated herein by reference.

### TECHNICAL FIELD

The present disclosure relates to apparatus for heating smokable material to volatilize at least one component of the smokable material.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present disclosure provides an apparatus for heating smokable material to volatilize at least one component of the smokable material, the apparatus comprising: a heating zone for receiving at least a portion of an article comprising smokable material; a magnetic field generator for generating a varying magnetic field; and an elongate heating element extending at least partially around the heating zone and comprising heating material that is heatable by penetration with the varying magnetic field to heat the heating zone.

In an exemplary embodiment, the heating zone is defined by the heating element.

In an exemplary embodiment, the heating zone is free of any heating material that is heatable by penetration with a varying magnetic field.

In an exemplary embodiment, the heating element is a tubular heating element that encircles the heating zone.

In an exemplary embodiment, the apparatus comprises a mass of thermal insulation encircling the heating element.

In an exemplary embodiment, the magnetic field generator comprises a coil and a device for passing a varying electrical current through the coil. The varying electrical current may be an alternating current.

In an exemplary embodiment, the coil encircles the heating element.

In an exemplary embodiment, the apparatus comprises a mass of thermal insulation between the coil and the heating element.

In an exemplary embodiment, the thermal insulation comprises one or more thermal insulators selected from the group consisting of: a closed-cell material, a closed-cell plastics material, an aerogel, vacuum insulation, silicone foam, a rubber material, wadding, fleece, non-woven material, non-woven fleece, woven material, knitted material, nylon, foam, polystyrene, polyester, polyester filament, polypropylene, a blend of polyester and polypropylene, cellulose acetate, paper or card, and corrugated material such as corrugated paper or card.

In an exemplary embodiment, the apparatus comprises a mass of thermal insulation encircling the coil.

In an exemplary embodiment, the thermal insulation comprises one or more thermal insulators selected from the group consisting of: a closed-cell material, a closed-cell plastics material, an aerogel, vacuum insulation, silicone foam, a rubber material, wadding, fleece, non-woven material, non-woven fleece, woven material, knitted material, nylon, foam, polystyrene, polyester, polyester filament, polypropylene, a blend of polyester and polypropylene, cellulose acetate, paper or card, and corrugated material such as corrugated paper or card.

In an exemplary embodiment, the apparatus comprises a gap of between about one and about three millimeters between an outermost surface of the heating element and an innermost surface of the coil. In an exemplary embodiment, the gap is between about 1.5 and about 2.5 millimeters.

In an exemplary embodiment, the coil extends along a longitudinal axis that is substantially aligned with a longitudinal axis of the elongate heating element. In an exemplary embodiment, the axes are coincident.

In an exemplary embodiment, an impedance of the coil is equal, or substantially equal, to an impedance of the heating element.

In an exemplary embodiment, an outer surface of the heating element has a thermal emissivity of 0.1 or less. In an exemplary embodiment, the thermal emissivity is 0.05 or less.

In an exemplary embodiment, the heating element comprises an elongate heating member extending at least partially around the heating zone and consisting entirely, or substantially entirely, of the heating material.

In respective exemplary embodiments, the heating material comprises one or more materials selected from the group consisting of: an electrically-conductive material, a magnetic material, and a non-magnetic material. In respective exemplary embodiments, the heating material comprises a metal or a metal alloy. In respective exemplary embodiments, the heating material comprises one or more materials selected from the group consisting of: aluminum, gold, iron, nickel, cobalt, conductive carbon, graphite, plain-carbon steel, stainless steel, ferritic stainless steel, copper, and bronze.

In an exemplary embodiment, the heating material is susceptible to eddy currents being induced in the heating material when penetrated by the varying magnetic field.

In an exemplary embodiment, a first portion of the heating element is more susceptible to eddy currents being induced therein by penetration with the varying magnetic field than a second portion of the heating element.

In an exemplary embodiment, the heating element comprises an elongate heating member comprising the heating material, and a coating on an inner surface of the heating member, wherein the coating is smoother or harder than the inner surface of the heating member. The coating may comprise glass or a ceramic material.

In an exemplary embodiment, the apparatus comprises a temperature sensor for sensing a temperature of the heating zone or of the heating element. In an exemplary embodiment, the magnetic field generator is arranged to operate on the basis of an output of the temperature sensor.

In an exemplary embodiment, the magnetic field generator is for generating a plurality of varying magnetic fields for penetrating different respective portions of the heating element.

In an exemplary embodiment, the apparatus comprises: a body comprising the magnetic field generator; and a mouthpiece that defines a passageway in fluid communication with the heating zone; wherein the mouthpiece is movable relative to the body to permit access to the heating zone and comprises the elongate heating element.

In an exemplary embodiment, the mouthpiece comprises the heating zone.

In an exemplary embodiment, the body comprises the heating zone.

A second aspect of the present disclosure provides an apparatus for heating smokable material to volatilize at least one component of the smokable material, the apparatus comprising: a heating zone for receiving at least a portion of an article comprising smokable material; a body comprising a magnetic field generator for generating a varying magnetic field; and a mouthpiece that defines a passageway in fluid communication with the heating zone, wherein the mouthpiece is movable relative to the body to permit access to the heating zone, and wherein the mouthpiece comprises a heating element comprising heating material that is heatable by penetration with the varying magnetic field to heat the heating zone.

In respective exemplary embodiments, the apparatus of the second aspect of the present disclosure may have any of the features of the above-described exemplary embodiments of the apparatus of the first aspect of the present disclosure.

A third aspect of the present disclosure provides a system, comprising: apparatus for heating smokable material to volatilize at least one component of the smokable material, the apparatus comprising a heating zone for receiving at least a portion of an article comprising smokable material, a magnetic field generator for generating a varying magnetic field, and an elongate heating element extending at least partially around the heating zone and comprising heating material that is heatable by penetration with the varying magnetic field to heat the heating zone; and the article for use with the apparatus, the article comprising the smokable material.

In respective exemplary embodiments, the apparatus of the system may have any of the features of the above-described exemplary embodiments of the apparatus of the first aspect of the present disclosure or of the second aspect of the present disclosure.

### BRIEF DESCRIPTION OF THE DRAWINGS

Embodiments of the disclosure will now be described, by way of example only, with reference to the accompanying drawings, in which:

FIG. 1 shows a schematic perspective view of a portion of an example of apparatus for heating smokable material to volatilize at least one component of the smokable material.

FIG. 2 shows a schematic cross-sectional view of the apparatus of which only the portion is shown in FIG. 1.

FIG. 3 shows a schematic cross-sectional view of an example of another apparatus for heating smokable material to volatilize at least one component of the smokable material.

FIG. 4 shows a schematic cross-sectional view of a heating element.

FIG. 5 shows a schematic cross-sectional view of an example of another apparatus for heating smokable material to volatilize at least one component of the smokable material.

FIG. 6 shows a schematic cross-sectional view of a mouthpiece of the apparatus of FIG. 5.

### DETAILED DESCRIPTION

As used herein, the term “smokable material” includes materials that provide volatilized components upon heating, typically in the form of vapor or an aerosol. “Smokable material” may be a non-tobacco-containing material or a tobacco-containing material. “Smokable material” may, for example, include one or more of tobacco per se, tobacco derivatives, expanded tobacco, reconstituted tobacco, tobacco extract, homogenized tobacco or tobacco substitutes. The smokable material can be in the form of ground tobacco, cut rag tobacco, extruded tobacco, liquid, gel, gelled sheet, powder, or agglomerates. “Smokable material” also may include other, non-tobacco, products, which, depending on the product, may or may not contain nicotine. “Smokable material” may comprise one or more humectants, such as glycerol or propylene glycol.

As used herein, the term “heating material” refers to material that is heatable by penetration with a varying magnetic field.

As used herein, the terms “flavor” and “flavorant” refer to materials which, where local regulations permit, may be used to create a desired taste or aroma in a product for adult consumers. They may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, gel, powder, or the like.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

It has been found that, when the susceptor is in the form of a closed circuit, magnetic coupling between the susceptor and the electromagnet in use is enhanced, which results in greater or improved Joule heating.

Magnetic hysteresis heating is a process in which an object made of magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

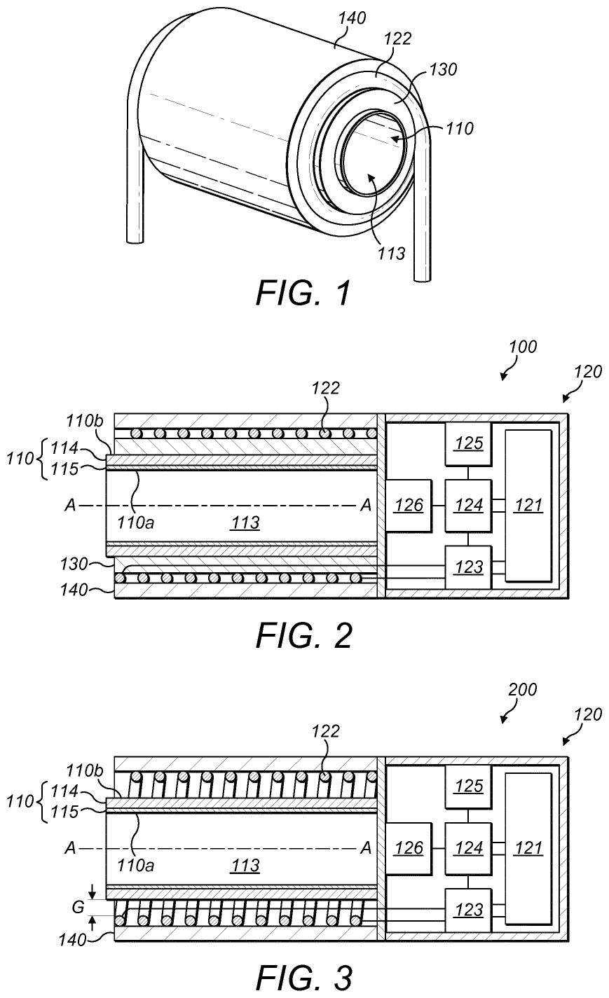

Referring to FIGS. 2 and 1 there are respectively shown a schematic cross-sectional view of an example of apparatus for heating smokable material to volatilize at least one component of the smokable material, according to an embodiment of the disclosure, and a schematic perspective view of a portion of the apparatus. Broadly speaking, the apparatus 100 comprises a heater or heating zone 113 for receiving at least a portion of an article comprising smokable material, a magnetic field generator 120 for generating a varying magnetic field, and an elongate heating element 110 extending around the heating zone 113 and comprising heater material or heating material that is heatable by penetration with the varying magnetic field to heat the heating zone 113.

In this embodiment, the heating element 110 is a tubular heating element 110 that encircles the heating zone 113. In this embodiment, the heating zone 113 comprises a cavity. However, in other embodiments, the heating element 110 may not be fully tubular. For example, in some embodiments, the heater or heating element 110 may be tubular save for an axially-extending gap or slit formed in the heating element 110. In this embodiment, the heating element 110 has a substantially circular cross section. However, in other embodiments, the heating element may have a cross section other than circular, such as square, rectangular, polygonal or elliptical.

In this embodiment, the heating zone 113 is defined by the heating element 110. That is, the heating element 110 delineates or delimits the heating zone 113. Moreover, in this embodiment, the heating zone 113 itself is free of any heating material that is heatable by penetration with a varying magnetic field. Thus, when a varying magnetic field is generated by the magnetic field generator 120 as discussed below, more energy of the varying magnetic field is available to cause heating of the heating element 110. In other embodiments, there may be a further heating element comprising heating material in the heating zone 113.

The heating element 110 of this embodiment comprises an elongate tubular heating member 114 extending around the heating zone 113 and consisting entirely, or substantially entirely, of the heating material. The heating member 114 thus comprises a closed circuit of heating material that is heatable by penetration with a varying magnetic field. Moreover, in this embodiment, the heating element 110 comprises a coating 115 on an inner surface of the heating member 114. The coating 115 is smoother or harder than the inner surface of the heating member 114 itself. Such a smoother or harder coating 115 may facilitate cleaning of the heating element 110 after use of the apparatus 100. The coating 115 could be made of glass or a ceramic material, for example. In other embodiments, the coating 115 may be omitted. In some embodiments, the coating may be rougher than the outer surface of the heating member 114 itself, so as to increase the surface area over which the heating element 110 is contactable with an article or smokable material inserted in the heating zone 113 in use.

The heating material may comprise one or more materials selected from the group consisting of: an electrically-conductive material, a magnetic material, and a non-magnetic material. The heating material may comprise a metal or a metal alloy. The heating material may comprise one or more materials selected from the group consisting of: aluminum, gold, iron, nickel, cobalt, conductive carbon, graphite, plain-carbon steel, stainless steel, ferritic stainless steel, copper, and bronze. Other material(s) may be used as the heating material in other embodiments. In this embodiment, the heating material of the heating element 110 comprises electrically-conductive material. Thus, the heating material is susceptible to eddy currents being induced in the heating material when penetrated by a varying magnetic field. Therefore, the heating element 110 is able to act as a susceptor when subjected to the changing magnetic field. It has also been found that, when magnetic electrically-conductive material is used as the heating material, magnetic coupling between the heating element 110 and the coil 122 of the magnetic field generator 120, which will be described below, in use may be enhanced. In addition to potentially enabling magnetic hysteresis heating, this can result in greater or improved Joule heating of the heating element 110, and thus greater or improved heating of the heating zone 113.

The heating element 110 preferably has a small thickness as compared to the other dimensions of the heating element 110. A susceptor may have a skin depth, which is an exterior zone within which most of an induced electrical current occurs. By providing that the heating element 110 has a relatively small thickness, a greater proportion of the heating element 110 may be heatable by a given varying magnetic field, as compared to a heating element 110 having a depth or thickness that is relatively large as compared to the other dimensions of the heating element 110. Thus, a more efficient use of material is achieved. In turn, costs are reduced.

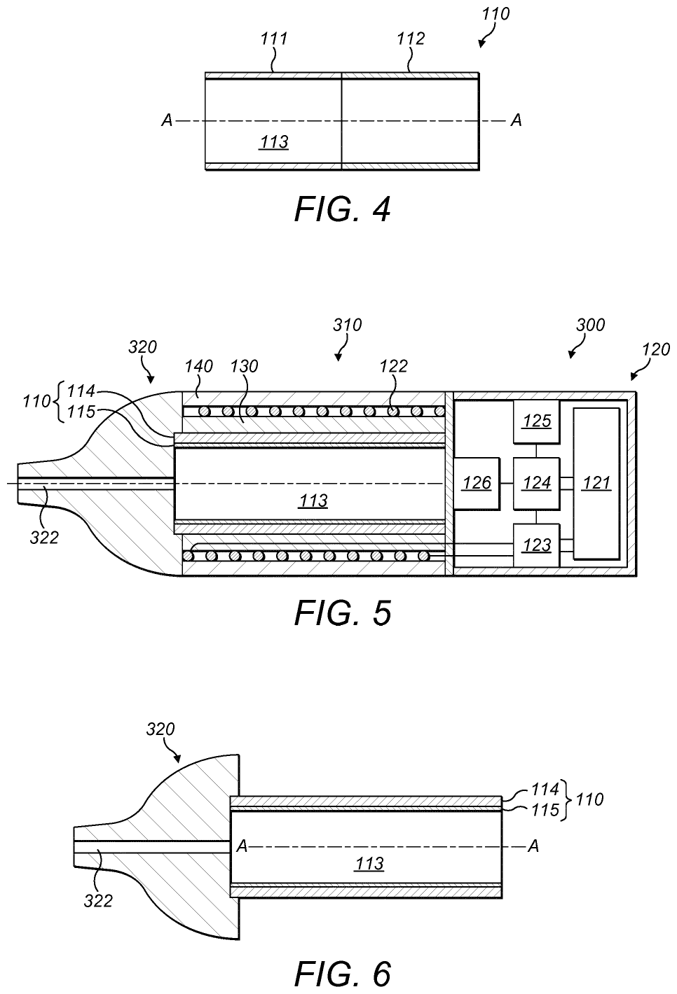

In some embodiments, a first portion of the heating element 110 is more susceptible to eddy currents being induced therein by penetration with the varying magnetic field than a second portion of the heating element 110. For example, in some embodiments, the heating element 110 in the apparatus 100 of FIG. 2 may be replaced by the heating element 110 shown in FIG. 4.

In the heating element 110 of FIG. 4, a first portion 111 of the heating element 110 is more susceptible to eddy currents being induced therein by penetration with a varying magnetic field than a second portion 112 of the heating element 110. The first portion 111 of the heating element 110 may have the higher susceptibility as a result of the first portion 111 of the heating element 110 being made of a first material, the second portion 112 of the heating element 110 being made of a different second material, and the first material being of a higher susceptibility than the second material. For example, one of the first and second portions 111, 112 may be made of iron, and the other of the first and second portions 111, 112 may be made of graphite. Alternatively or additionally, the first portion 111 of the heating element 110 may have the higher susceptibility as a result of the first portion 111 of the heating element 110 having a different thickness and/or material density to the second portion 112 of the heating element 110.

The higher susceptibility portion 111 may be located closer to an intended mouth end of the apparatus 100, or the lower susceptibility portion 112 may be located closer to the intended mouth end of the apparatus 100. In the latter scenario, the lower susceptibility portion 112 may heat smokable material in an article located in the heating zone 113 to a lesser degree than the higher susceptibility portion 112, and thus the lesser heated smokable material could act as a filter, to reduce the temperature of created vapor or make the vapor created in the article mild during heating of the smokable material.

While in FIG. 4 the first and second portions 111, 112 are located adjacent each other in the longitudinal direction of the heating element 110, in other embodiments this need not be the case. For example, in some embodiments the first and second portions 111, 112 may be disposed adjacent each other in a direction perpendicular to the longitudinal direction of the heating element 110.

Such varying susceptibility of the heating element 110 to eddy currents being induced therein can help achieve progressive heating of smokable material in an article inserted in the heating zone 113, and thereby progressive generation of vapor. For example, the higher susceptibility portion 111 may be able to heat a first region of the smokable material relatively quickly to initialize volatilization of at least one component of the smokable material and formation of a vapor in the first region of the smokable material. The lower susceptibility portion 112 may be able to heat a second region of the smokable material relatively slowly to initialize volatilization of at least one component of the smokable material and formation of a vapor in the second region of the smokable material. Accordingly, a vapor is able to be formed relatively rapidly for inhalation by a user, and vapor can continue to be formed thereafter for subsequent inhalation by the user even after the first region of the smokable material may have ceased generating vapor. The first region of the smokable material may cease generating the vapor when it becomes exhausted of volatilizable components of the smokable material.

In other embodiments, all of the heating element 110 may be equally, or substantially equally, susceptible to eddy currents being induced therein by penetration with a varying magnetic field. In some embodiments, the heating element 110 may not be susceptible to such eddy currents. In such embodiments, the heating material may be a magnetic material that is non-electrically-conductive, and thus may be heatable by the magnetic hysteresis process discussed above.

In some embodiments, the apparatus may comprise a catalytic material on at least a portion of an inner surface 110a of the heating element 110. The catalytic material may be provided on all of the inner surface 110a of the heating element 110, or on only some portion(s) of the inner surface 110a of the heating element 110. The catalytic material may take the form of a coating. The provision of such a catalytic material means that, in use, the apparatus 100 may have a heated, chemically active surface. In use, the catalytic material may act to convert, or increase the rate of conversion of, a potential irritant to something that is less of an irritant. In use, the catalytic material may act to convert, or increase the rate of conversion of, formic acid to methanol, for example. In other embodiments, the catalytic material may act to convert, or increase the rate of conversion of, other chemicals, such as acetylene to ethane by hydrogenation, or ammonia to nitrogen and hydrogen. The catalytic material may additionally or alternatively act to react, or increase the rate of reaction of, carbon monoxide and water vapor to form carbon dioxide and hydrogen (the water-gas shift reaction, or WGSR).

In some embodiments, an outer surface 110b of the heating element 110 may have a thermal emissivity of 0.1 or less. For example, in some embodiments, the outer surface 110b of the heating element 110 may have a thermal emissivity of 0.05 or less, such as 0.03 or 0.02. Such low emissivity helps to retain heat in the heating element 110 and in the heating zone 113 and provide some or all of the other thermal benefits of the thermal insulation discussed below. The thermal emissivity may be achieved by making the outer surface 110b of the heating element 110 from a low emissivity material, such as silver or aluminum.

The magnetic field generator 120 of this embodiment comprises an electrical power source 121, the coil 122, a device 123 for passing a varying electrical current, such as an alternating current, through the coil 122, a controller 124, and a user interface 125 for user-operation of the controller 124.

In this embodiment, the electrical power source 121 is a rechargeable battery. In other embodiments, the electrical power source 121 may be other than a rechargeable battery, such as a non-rechargeable battery, a capacitor or a connection to a mains electricity supply.

The coil 122 may take any suitable form. In this embodiment, the coil 122 is a helical coil of electrically-conductive material, such as copper. In some embodiments, the magnetic field generator 120 may comprise a magnetically permeable core around which the coil 122 is wound. Such a magnetically permeable core concentrates the magnetic flux produced by the coil 122 in use and makes a more powerful magnetic field. The magnetically permeable core may be made of iron, for example. In some embodiments, the magnetically permeable core may extend only partially along the length of the coil 122, so as to concentrate the magnetic flux only in certain regions.

In this embodiment, the coil 122 is a circular helix. That is, the coil 122 has a substantially constant radius along its length. In other embodiments, the radius of the coil 122 may vary along its length. For example, in some embodiments, the coil 122 may comprise a conic helix or an elliptical helix. In this embodiment, the coil 122 has a substantially constant pitch along its length. That is, a width measured parallel to the longitudinal axis of the coil 122 of a gap between any two adjacent turns of the coil 122 is substantially the same as a width of a gap between any other two adjacent turns of the coil 122. In other embodiments, this may not be true. The provision of a varying pitch may enable the strength of a varying magnetic field produced by the coil 122 to be different at different portions of the coil 122, which may help provide progressive heating of the heating element 110 and heating zone 113, and thus any article located in the heating zone 113, in a manner similar to that described above.

In this embodiment, the coil 122 is in a fixed position relative to the heating element 110 and the heating zone 113. In this embodiment, the coil 122 encircles the heating element 110 and the heating zone 113. In this embodiment, the coil 122 extends along a longitudinal axis that is substantially aligned with a longitudinal axis A-A of the heating zone 113. In this embodiment, the aligned axes are coincident. In a variation to this embodiment, the aligned axes may be parallel to each other. However, in other embodiments, the axes may be oblique to each other. Moreover, in this embodiment, the coil 122 extends along a longitudinal axis that is substantially coincident with a longitudinal axis of the heating element 110. This can help to provide more uniform heating of the heating element 110 in use, and can also aid manufacturability of the apparatus 100. In other embodiments, the longitudinal axes of the coil 122 and the heating element 110 may be aligned with each other by being parallel to each other, or may be oblique to each other.

An impedance of the coil 122 of the magnetic field generator 120 of this embodiment is equal, or substantially equal, to an impedance of the heating element 110. If the impedance of the heating element 110 were instead lower than the impedance of the coil 122 of the magnetic field generator 120, then the voltage generated across the heating element 110 in use may be lower than the voltage that may be generated across the heating element 110 when the impedances are matched. Alternatively, if the impedance of the heating element 110 were instead higher than the impedance of the coil 122 of the magnetic field generator 120, then the electrical current generated in the heating element 110 in use may be lower than the current that may be generated in the heating element 110 when the impedances are matched. Matching the impedances may help to balance the voltage and current to maximize the heating power generated at the heating element 110 when heated in use. In some other embodiments, the impedances may not be matched.

In this embodiment, the device 123 for passing a varying current through the coil 122 is electrically connected between the electrical power source 121 and the coil 122. In this embodiment, the controller 124 also is electrically connected to the electrical power source 121, and is communicatively connected to the device 123. The controller 124 is for causing and controlling heating of the heating element 110. More specifically, in this embodiment, the controller 124 is for controlling the device 123, so as to control the supply of electrical power from the electrical power source 121 to the coil 122. In this embodiment, the controller 124 comprises an integrated circuit (IC), such as an IC on a printed circuit board (PCB). In other embodiments, the controller 124 may take a different form. In some embodiments, the apparatus may have a single electrical or electronic component comprising the device 123 and the controller 124. The controller 124 is operated in this embodiment by user-operation of the user interface 125. The user interface 125 is located at the exterior of the apparatus 100. The user interface 125 may comprise a push-button, a toggle switch, a dial, a touchscreen, or the like.

In this embodiment, operation of the user interface 125 by a user causes the controller 124 to cause the device 123 to cause an alternating electrical current to pass through the coil 122, so as to cause the coil 122 to generate an alternating magnetic field. The coil 122 and the heating element 110 are suitably relatively positioned so that the alternating magnetic field produced by the coil 122 penetrates the heating material of the heating element 110. When the heating material of the heating element 110 is an electrically-conductive material, this may cause the generation of one or more eddy currents in the heating material. The flow of eddy currents in the heating material against the electrical resistance of the heating material causes the heating material to be heated by Joule heating. As mentioned above, when the heating material is made of a magnetic material, the orientation of magnetic dipoles in the heating material changes with the changing applied magnetic field, which causes heat to be generated in the heating material.

The apparatus 100 of this embodiment comprises a temperature sensor 126 for sensing a temperature of the heating zone 113. The temperature sensor 126 is communicatively connected to the controller 124, so that the controller 124 is able to monitor the temperature of the heating zone 113. In some embodiments, the temperature sensor 126 may be arranged to take an optical temperature measurement of the heating zone 113 or an article located in the heating zone 113. In some embodiments, the article to be located in the heating zone 113 may comprise a temperature detector, such as a resistance temperature detector (RTD), for detecting a temperature of the article. The article may further comprise one or more terminals connected, such as electrically-connected, to the temperature detector. The terminal(s) may be for making connection, such as electrical connection, with a temperature monitor (not shown) of the apparatus 100 when the article is in the heating zone 113. The controller 124 may comprise the temperature monitor. The temperature monitor of the apparatus 100 may thus be able to determine a temperature of the article during use of the article with the apparatus 100.

On the basis of one or more signals received from the temperature sensor 126 (and/or temperature detector, when provided), the controller 124 may cause the device 123 to adjust a characteristic of the varying or alternating electrical current passed through the coil 122 as necessary, in order to ensure that the temperature of the heating zone 113 remains within a predetermined temperature range. The characteristic may be, for example, amplitude or frequency. Within the predetermined temperature range, in use smokable material within an article located in the heating zone 113 is heated sufficiently to volatilise at least one component of the smokable material without combusting the smokable material. Accordingly, the controller 124, and the apparatus 100 as a whole, is arranged to heat the smokable material to volatilize the at least one component of the smokable material without combusting the smokable material. In some embodiments, the temperature range is about 50° C. to about 250° C., such as between about 50° C. and about 150° C., between about 50° C. and about 120° C., between about 50° C. and about 100° C., between about 50° C. and about 80° C., or between about 60° C. and about 70° C. In some embodiments, the temperature range is between about 170° C. and about 220° C. In other embodiments, the temperature range may be other than these ranges.

In some embodiments, the apparatus 100 may comprises a mouthpiece (not shown). The mouthpiece may be releasably engageable with the rest of the apparatus 100 so as to connect the mouthpiece to the rest of the apparatus 100. In other embodiments, the mouthpiece and the rest of the apparatus 100 may be permanently connected, such as through a hinge or flexible member.

The mouthpiece may be locatable relative to the heating element 110 so as to cover an opening into the heating zone 113 through which the article is insertable into the heating zone 113. When the mouthpiece is so located relative to the heating element 110, a channel through the mouthpiece may be in fluid communication with the heating zone 113. In use, the channel acts as a passageway for permitting volatilized material to pass from the heating zone 113 to an exterior of the apparatus 100.

As the heating zone 113, and thus any article therein, is being heated, a user may be able to inhale the volatilized component(s) of the smokable material by drawing the volatilized component(s) through a mouthpiece of the article (when provided) or through a mouthpiece of the apparatus 100 (when provided). Air may enter the article via a gap between the article and the heating element 110, or in some embodiments the apparatus 100 may define an air inlet that fluidly connects the heating zone 113 with the exterior of the apparatus 100. As the volatilized component(s) are removed from the article, air may be drawn into the heating zone 113 via the air inlet of the apparatus 100.

In this embodiment, the apparatus 100 comprises a first mass of thermal insulation 130 between the coil 122 and the heating element 110. The first mass of thermal insulation 130 encircles the heating element 110. In this embodiment, the first mass of thermal insulation 130 comprises a closed-cell plastics material. However, in other embodiments, the first mass of thermal insulation 130 may comprise, for example, one or more thermal insulators selected from the group consisting of: a closed-cell material, a closed-cell plastics material, an aerogel, vacuum insulation, silicone foam, a rubber material, wadding, fleece, non-woven material, non-woven fleece, woven material, knitted material, nylon, foam, polystyrene, polyester, polyester filament, polypropylene, a blend of polyester and polypropylene, cellulose acetate, paper or card, and corrugated material such as corrugated paper or card. The thermal insulation may additionally or alternatively comprise an air gap. Such a first mass of thermal insulation 130 may help to prevent heat loss from the heating element 110 to components of the apparatus 100 other than the heating zone 113, may help to increase heating efficiency of the heating zone 113, and/or may help to reduce the transfer of heating energy from the heating element 110 to an outer surface of the apparatus 100. This may improve the comfortableness with which a user is able to hold the apparatus 100.

In this embodiment, the apparatus 100 also comprises a second mass of thermal insulation 140 that encircles the coil 122. In this embodiment, the second mass of thermal insulation 140 comprises wadding or fleece. However, in other embodiments, the second mass of thermal insulation 140 may comprise, for example, one or more materials selected from the group consisting of: aerogel, vacuum insulation, wadding, fleece, non-woven material, non-woven fleece, woven material, knitted material, nylon, foam, polystyrene, polyester, polyester filament, polypropylene, a blend of polyester and polypropylene, cellulose acetate, paper or card, corrugated material such as corrugated paper or card, a closed-cell material, a closed-cell plastics material, an aerogel, vacuum insulation, silicone foam, a rubber material. In some embodiments, the second mass of thermal insulation 140 may comprise one or more of the materials discussed above for the first mass of thermal insulation 130. The thermal insulation may additionally or alternatively comprise an air gap. Such a second mass of thermal insulation 140 may help to reduce the transfer of heating energy from the heating element 110 to an outer surface of the apparatus 100, and may additionally or alternatively help to increase heating efficiency of the heating zone 113.

In some embodiments, one or both of the first and second masses of thermal insulation 130, 140 may be omitted. In some embodiments, the coil 122 may be embedded in a body of thermal insulation. Such a body of thermal insulation may abut or envelop the heating element 110. The body of thermal insulation could, for example, occupy the spaces occupied by the first and second masses of thermal insulation 130, 140 in the apparatus 100 of FIGS. 1 and 2, in addition to enveloping the coil 122. Such a body of thermal insulation may comprise, for example, one or more thermal insulators selected from the group consisting of: a closed-cell material, a closed-cell plastics material, an aerogel, vacuum insulation, silicone foam, and a rubber material. In addition to the thermal benefits discussed above, such a body of thermal insulation may help to increase the robustness of the apparatus 100, such as by helping to maintain the relative positioning of the coil 122 and the heating element 110. The body of thermal insulation may be manufactured by pouring the material of the body of thermal insulation around the coil 122 and against or around the heating element 110, to provide a potted coil 122 and heating element 110.

In some embodiments, the apparatus 100 comprises a gap between an outermost surface 110b of the heating element 110 and an innermost surface of the coil 122. In some such embodiments, the first mass of thermal insulation 130 may be omitted. An example such embodiment is shown in FIG. 3. Referring to FIG. 3, there is shown a schematic cross-sectional view of an example of another apparatus for heating smokable material to volatilize at least one component of the smokable material, according to an embodiment of the invention. The apparatus 200 of this embodiment is identical to the apparatus 100 of FIGS. 1 and 2 except for the omission of the first mass of thermal insulation 130. Any of the above-described possible variations to the apparatus of FIGS. 1 and 2 may be made to the apparatus 200 of FIG. 3 to form separate respective embodiments.

Although the dimensions in FIG. 3 are accentuated for clarity, the apparatus 200 comprises a gap G of about two millimeters between an outermost surface 110b of the heating element 110 and an innermost surface of the coil 122. In a variation to this embodiment, the gap G may be of other than two millimeters, such as between about one and about three millimeters or between about 1.5 and about 2.5 millimeters. Such a gap G can, in itself, act as a thermal insulator to help provide some or all of the thermal benefits discussed above. In an embodiment such as that shown in FIG. 3, the heating element 110 may be suspended in the coil 122. The heating element 110 may be supported through attachment to the wall to which the temperature sensor 126 is mounted.

Some embodiments of the apparatus 100 may be arranged to provide “self-cleaning” of the heating element 110. For example, in some embodiments, the controller 124 may be arranged, such as on suitable user operation of the user interface 125, to cause the device 123 to adjust a characteristic of the varying or alternating electrical current passed through the coil 122 as necessary, in order to increase the temperature of the heating element 110 to a level at which residue or leftovers on the heating element 110 from a previously expended article may be incinerated. The characteristic may be, for example, amplitude or frequency. The temperature may be, for example, in excess of 500 degrees Celsius.

Some embodiments of the apparatus 100 may be arranged to provide haptic feedback to a user. The feedback could indicate that heating is taking place, or be triggered by a timer to indicate that greater than a predetermined proportion of the original quantity of volatilizable component(s) of the smokable material in an article in the heating zone 113 has/have been spent, or the like. The haptic feedback could be created by interaction of the coil 122 and the heating element 110 (i.e. magnetic response), by interaction of an electrically-conductive element with the coil 122, by rotating an unbalanced motor, by repeatedly applying and removing a current across a piezoelectric element, or the like. Additionally or alternatively, some embodiments of the apparatus 100 may utilize such haptics to aid the “self-cleaning” process discussed above, by vibration cleaning the heating element 110.

In some embodiments, the magnetic field generator 120 may be for generating a plurality of varying magnetic fields for penetrating different respective portions of the heating element 110. For example, the apparatus 100 may comprise more than one coil. The plurality of coils of the apparatus 100 could be operable to provide progressive heating of the heating element 110, and thus progressive heating of smokable material in an article located in the heating zone 113, so as to provide progressive generation of vapor. For example, one coil may be able to heat a first region of the heating material relatively quickly to initialize volatilization of at least one component of the smokable material and formation of a vapor in a first region of the smokable material. Another coil may be able to heat a second region of the heating material relatively slowly to initialize volatilization of at least one component of the smokable material and formation of a vapor in a second region of the smokable material. Accordingly, a vapor is able to be formed relatively rapidly for inhalation by a user, and vapor can continue to be formed thereafter for subsequent inhalation by the user even after the first region of the smokable material may have ceased generating vapor. The initially-unheated second region of smokable material could act as a filter, to reduce the temperature of created vapor or make the created vapor mild, during heating of the first region of smokable material.

Referring to FIGS. 5 and 6, there are shown a schematic cross-sectional view of an example of another apparatus for heating smokable material to volatilize at least one component of the smokable material, according to an embodiment of the disclosure, and a schematic cross-sectional view of a mouthpiece of the apparatus. The apparatus 300 of this embodiment is identical to the apparatus 100 of FIGS. 1 and 2 except for the provision of a mouthpiece 320, and the provision that the mouthpiece 320 comprises the heating element 110 and the heating zone 113. Any of the above-described possible variations to the apparatus 100 of FIGS. 1 and 2 may be made to the apparatus 300 of FIGS. 5 and 6 to form separate respective embodiments.

The apparatus 300 of this embodiment comprises a body 310 and a mouthpiece 320. The body 310 comprises the magnetic field generator 120. The body 310 is the same as the apparatus 100 shown in FIGS. 1 and 2, except that the heating element 110, and the heating zone 113 therein, is instead comprised in the mouthpiece 320 and is removable from within the first mass of thermal material 130 on movement of the mouthpiece 320 relative to the body 310, as shown in FIG. 6.

In the position relative to the mouthpiece 320 as shown in FIG. 5, the body 310 of the apparatus 300 covers an opening into the heating zone 113 through which an article is insertable into the heating zone 113. When the mouthpiece 320 is so located relative to the body 310, a passageway 322 defined by the mouthpiece 320 is in fluid communication with the heating zone 113 and places the heating zone 113 in fluid communication with the exterior of the apparatus 300. In use of the apparatus 300, the passageway 322 permits volatilized material to pass from the heating zone 113 to the exterior of the apparatus 300.

The mouthpiece 320 is movable relative to the body 310 to permit access to the heating zone 113 from an exterior of the apparatus 300, such as for insertion or removal of an article or for cleaning the heating zone 113. The provision of the mouthpiece 320 may create a through bore through the heating zone 113, which permits cleaning along the full length of the heating zone 113. In this embodiment, the mouthpiece 320 is releasably engageable with the body 310 so as to connect the mouthpiece 320 to the body 310. Thus, the mouthpiece 320 may be fully detachable from the body 310, as shown in FIG. 6. In some embodiments, the mouthpiece 320 may be disposable with the heating element 110. In other embodiments, the mouthpiece 320 and the body 310 may be permanently connected, such as through a hinge or flexible member. The mouthpiece 320 is movable relative to the body 310 from the position shown in FIG. 6 to the position shown in FIG. 5, so as to cause the coil 122 to encircle the heating element 110.

The mouthpiece 320 of the apparatus 300 may comprise or be impregnated with a flavorant. The flavorant may be arranged so as to be picked up by hot vapor as the vapor passes through the passageway 322 of the mouthpiece 320 in use.

In other embodiments of the apparatus 300, the heating element comprised by the mouthpiece may take a different form. For example, the heating element could comprises a rod or strip comprising heating material that is heatable by penetration with the varying magnetic field to heat the heating zone 113. The heating element may be for insertion into an article comprising smokable material and received in the heating zone 113, for example. The heating zone 113 may be comprised in the body 310 of the apparatus 300, or in the mouthpiece 320. For example, in some embodiments, the heating element is inserted into the heating zone 113 as the mouthpiece 320 is moved relative to the body 310 of the apparatus 300. In other embodiments, the mouthpiece 320 comprises one or more components that together define the heating zone 113 and the heating element is located in the heating zone 113.

In some embodiments, the apparatus may have a mechanism for compressing the article when the article is inserted in the recess or cooperating with the interface. Such compression of the article can compress the smokable material in the article, so as to increase the thermal conductivity of the smokable material. In other words, compression of the smokable material can provide for higher heat transfer through the article. For example, in some embodiments, the apparatus may comprise first and second members between which the heating zone 113 is located. The first and second members may be movable towards each other to compress the heating zone 113. In some embodiments, the first and second members may be free of any heating material. Thus, when a varying magnetic field is generated by the magnetic field generator 120, more energy of the varying magnetic field is available to cause heating of the heating element 110. However, in other embodiments, one or both of the first and second members may comprise heating material that is heatable by penetration with the varying magnetic field generated by the magnetic field generator 120. This may provide further and/or more uniform heating of the smokable material of the article.

In some embodiments, the heating material of the heating element 110 may comprise discontinuities or holes therein. Such discontinuities or holes may act as thermal breaks to control the degree to which different regions of the smokable material are heated in use. Areas of the heating material with discontinuities or holes therein may be heated to a lesser extent that areas without discontinuities or holes. This may help progressive heating of the smokable material, and thus progressive generation of vapor, to be achieved.

In each of the above described embodiments, the smokable material comprises tobacco. However, in respective variations to each of these embodiments, the smokable material may consist of tobacco, may consist substantially entirely of tobacco, may comprise tobacco and smokable material other than tobacco, may comprise smokable material other than tobacco, or may be free of tobacco. In some embodiments, the smokable material may comprise a vapor or an aerosol forming agent or a humectant, such as glycerol, propylene glycol, triactein, or diethylene glycol.

In some embodiments, the article discussed above is sold, supplied or otherwise provided separately from the apparatus 100, 200, 300 with which it is usable. However, in some embodiments, the apparatus 100, 200, 300 and one or more of the articles may be provided together as a system, such as a kit or an assembly, possibly with additional components, such as cleaning utensils.

Embodiments of the disclosure could be implemented in a system comprising any one of the articles discussed herein, and any one of the apparatuses discussed herein, wherein the article itself further has heating material, such as in a susceptor, for heating by penetration with the varying magnetic field generated by the magnetic field generator. Heat generated in the heating material of the article itself could be transferred to the smokable material to further heat the smokable material therein.

In order to address various issues and advance the art, the entirety of this disclosure shows by way of illustration and example various embodiments in which the claimed invention may be practiced and which provide for superior apparatus for heating smokable material to volatilize at least one component of the smokable material. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An apparatus configured to heat smokable material to volatilize at least one component of the smokable material, the apparatus comprising:
a heater zone configured to receive at least a portion of an article including smokable material;
a magnetic field generator configured to generate a varying magnetic field; and
an elongate heater element disposed at least partially around the heater zone and including heater material that is heatable by penetration with the varying magnetic field to thereby heat the heater zone.

2. The apparatus of claim 1, wherein the heater zone is defined by the heater element, and wherein the heater zone is free of any heater material that is heatable by penetration with a varying magnetic field.

3. The apparatus of claim 1, wherein the heater element is a tubular heater element that encircles the heater zone.

4. The apparatus of claim 1, further comprising a mass of thermal insulation encircling the heater element.

5. The apparatus of claim 1, wherein the magnetic field generator includes a coil and a device configured to pass a varying electrical current through the coil.

6. The apparatus of claim 5, wherein the coil encircles the heater element.

7. The apparatus of claim 6, further comprising a mass of thermal insulation disposed between the coil and the heater element.

8. The apparatus of claim 7, wherein the thermal insulation includes one or more thermal insulators selected from the group consisting of: a closed-cell material, a closed-cell plastics material, an aerogel, vacuum insulation, silicone foam, a rubber material, wadding, fleece, non-woven material, non-woven fleece, woven material, knitted material, nylon, foam, polystyrene, polyester, polyester filament, polypropylene, a blend of polyester and polypropylene, cellulose acetate, paper, card, and corrugated material.

9. The apparatus of claim 6, further comprising a mass of thermal insulation encircling the coil.

10. The apparatus of claim 6, wherein a gap of between about one millimeter and about three millimeters is defined between an outermost surface of the heater element and an innermost surface of the coil.

11. (canceled)

12. The apparatus of claim 5, wherein an impedance of the coil is equal, or substantially equal, to an impedance of the heater element.

13. The apparatus of claim 1, wherein an outer surface of the heater element has a thermal emissivity of 0.1 or less.

14. (canceled)

15. The apparatus of claim 1, wherein the heater material includes one or more materials selected from the group consisting of: an electrically-conductive material, a magnetic material, and a non-magnetic material.

16. The apparatus of claim 1, wherein the heater material includes a metal or a metal alloy.

17. The apparatus of claim 1, wherein the heater material one or more materials selected from the group consisting of: aluminum, gold, iron, nickel, cobalt, conductive carbon, graphite, plain-carbon steel, stainless steel, ferritic stainless steel, copper, and bronze.

18. (canceled)

19. The apparatus of claim 1, wherein a first portion of the heater element is more susceptible to eddy currents induced therein by penetration with a varying magnetic field than a second portion of the heater element.

20. The apparatus of claim 1, wherein the heater element includes: an elongate heater member comprising the heater material, and a coating disposed on an inner surface of the heater member, wherein the coating is smoother or harder than the inner surface of the heater member.

21. The apparatus of claim 1, further comprising:
a body including the magnetic field generator; and
a mouthpiece that defines a passageway that is in fluid communication with the heater zone;
wherein the mouthpiece is movable relative to the body to permit access to the heater zone, and the mouthpiece includes the elongate heater element.

22. An apparatus configured to heat smokable material to volatilize at least one component of the smokable material, the apparatus comprising:
a heater zone defined therein and configured to receive at least a portion of an article comprising smokable material;
a body including a magnetic field generator configured to generate a varying magnetic field; and
a mouthpiece that defines a passageway that is in fluid communication with the heater zone, the mouthpiece movable relative to the body to permit access to the heater zone, the mouthpiece including a heater element comprising heater material that is heatable by penetration with the varying magnetic field to, in use, heat the heater zone.

23. A system, comprising:
an article comprising a smokable material; and
an apparatus for heating the smokable material to volatilize at least one component of the smokable material, the apparatus comprising a heating zone for receiving at least a portion of the article comprising the smokable material, a magnetic field generator for generating a varying magnetic field, and an elongate heating element extending at least partially around the heating zone and comprising heating material that is heatable by penetration with the varying magnetic field to heat the heating zone.
